(19) United States
(12) Patent Application Publication
(10) Pub. No.: US 2026/0023010 A1
(43) Pub. Date: Jan. 22, 2026

(54) METHOD FOR DETERMINING SURFACE ADHESION OF OBJECT AND DEVICE THEREOF

(71) Applicant: Samsung Display Co., LTD., Yongin-si (KR)

(72) Inventor: Teck Soo KIM, Yongin-si (KR)

(21) Appl. No.: 18/981,055

(22) Filed: Dec. 13, 2024

(30) Foreign Application Priority Data
Jul. 18, 2024 (KR) 10-2024-0095199

(51) Int. Cl. G01N 19/04; G01B 11/30; G06F 1/16

(52) U.S. Cl. CPC G01N 19/04; G01B 11/303; G06F 1/1603

(57) ABSTRACT

A method for determining surface adhesion of an object includes: acquiring a plurality of index values for roughness based on a shape of an object surface; inputting the plurality of index values into a pre-trained adhesion prediction model, and outputting an adhesion predictive value of the object surface; and determining an adhesion quality of the object surface based on the adhesion predictive value.

This application claims priority to Korean Patent Application No. 10-2024-0095199, filed on Jul. 18, 2024, and all the benefits accruing therefrom under 35 U.S.C. § 119, the content of which in its entirety is herein incorporated by reference.

### BACKGROUND

### (1) Field

Embodiments of the disclosure relate to a method for determining surface adhesion of an object and a device thereof, i.e., a device for performing (or used to perform) the method, and more specifically, to a method for determining surface adhesion of an object based on a pre-trained adhesion prediction model and a device thereof.

### (2) Description of the Related Art

Typically, a cover glass of an electronic device may be designed and tested to have appropriate adhesion on a surface thereof or a surface of a light-shielding layer formed thereon in a manufacturing process thereof to prevent the cover glass, which is attached to a housing or display of the electronic device, from being separated or peeled off in a typical usage environment. Accordingly, an adhesion test may be performed on a surface of the cover glass or a surface of a light-shielding layer formed thereon.

### SUMMARY

In a case where the dyne pen evaluation method among the methods for testing adhesion is used as an adhesion test method, the adhesion of the cover glass is determined by measuring an energy of the surface to visually represent the adhesion. In this case, it may be difficult to accurately quantify the adhesion, as well as the cover glass is separated by a force smaller than the expected adhesion.

In a case where the push-out evaluation method is used as an adhesion test method, equipment for performing push-out evaluation is typically expensive, and it would take long time in the preparation process for testing the adhesion of the cover glass.

Accordingly, it may be desired to develop a technique for accurately checking the adhesion of the cover glass in shorter time and at lower costs.

Various embodiments of the disclosure provide a method for determining adhesion of an object surface by using an adhesion prediction model pre-trained based on artificial intelligence and values of indices for surface roughness of the object for which adhesion is to be determined, and a device thereof.

According to an embodiment of the invention, a method for determining surface adhesion of an object includes: acquiring a plurality of index values for roughness based on a shape of an object surface; inputting the plurality of index values into a pre-trained adhesion prediction model, and outputting an adhesion predictive value of the object surface; and determining an adhesion quality of the object surface based on the adhesion predictive value.

In an embodiment, the plurality of index values may include index values measured for a plurality of preset indices selected from roughness indices including arithmetical mean height (Sa), maximum height (Sz), arithmetic mean peak curvature (Spc), root mean square height (Sq), auto-correlation length (Sal), texture direction (Std), density of peaks (Spd), core height (Sk), peak material portion (Smr1), dale void volume (Vvv), and core material volume (Vmc).

In an embodiment, the object may be a cover glass having one surface as an adhesive surface, and a region of the adhesive surface is adhered to a bonding object, which is an object to be bonded, and the object surface may be a surface of a black matrix ink layer formed in the region of the adhesive surface of the object.

In an embodiment, the plurality of index values may include values measured for a plurality of preset indices of the roughness through a non-destructive laser-based surface shape scan of the object surface.

In an embodiment, the surface adhesion may be a maximum force applied to the object until the object is separated from a bonding object, which is an object to be bonded, while the object is adhered to the bonding object.

In an embodiment, the determining an adhesion quality may include determining the adhesion quality as non-defective if the adhesion predictive value exceeds a preset value, and determining the adhesion quality as defective if the adhesion predictive value is the preset value or less.

In an embodiment, the pre-trained adhesion prediction model may be generated by acquiring a dataset which includes learning index values for a plurality of preset indices of the roughness for each of a plurality of learning object surfaces, and learning adhesion measurement values for each of the plurality of learning object surfaces, and training to predict adhesion of the object surface when the plurality of index values for the object surface are input based on the dataset.

In an embodiment, the outputting the adhesion predictive value may include outputting a contribution degree indicating that each of the plurality of indices corresponding to the plurality of index values contributes to predicting the adhesion of the object surface by applying an explainable artificial intelligence algorithm to the adhesion prediction model.

In an embodiment, the method may further include, after the determining the adhesion quality of the object surface, outputting results of determining the adhesion quality of the object surface and the contribution degrees of the plurality of indices.

In an embodiment, the outputting the adhesion predictive value may include outputting a prediction accuracy of the adhesion predictive value, which is determined based on a degree to which a contribution degree ranking of preset indices selected from the plurality of indices matches a preset ranking.

According to another embodiment of the invention, a device for determining surface adhesion of an object includes: a storage unit which stores a pre-trained adhesion prediction model; and a processing unit which acquires a plurality of index values for roughness based on a shape of an object surface, inputs the plurality of index values into the pre-trained adhesion prediction model, outputs an adhesion predictive value of the object surface, and determines an adhesion quality of the object surface based on the adhesion predictive value.

In an embodiment, the plurality of index values may include index values measured for a plurality of preset indices selected from roughness indices including arithmetical mean height (Sa), maximum height (Sz), arithmetic mean peak curvature (Spc), root mean square height (Sq), auto-correlation length (Sal), texture direction (Std), density of peaks (Spd), core height (Sk), peak material portion (Smr1), dale void volume (Vvv), and core material volume (Vmc).

In an embodiment, the object may be a cover glass having one surface as an adhesive surface, and a region of the adhesive surface is adhered to a bonding object, which is an object to be bonded, and the object surface may be a surface of a black matrix ink layer formed in the region of the adhesive surface of the object.

In an embodiment, the device may further include a surface scanning unit which measures the plurality of index values for the roughness of the object surface through a non-destructive laser-based surface shape scan, where the processing unit may perform the non-destructive laser-based surface shape scan on the object surface through the surface scanning unit, and process to acquire the plurality of index values measured for the roughness.

In an embodiment, the surface adhesion may be a maximum force applied to the object until it is separated from a bonding object, which is an object to be bonded, while the object is adhered to the bonding object.

In an embodiment, the processing unit may determine the adhesion quality as non-defective if the adhesion predictive value exceeds a preset value, and determines the adhesion quality as defective if the adhesion predictive value is the preset value or less.

In an embodiment, the processing unit may generate the pre-trained adhesion prediction model by acquiring a dataset which includes learning index values for a plurality of preset indices of the roughness for each of a plurality of learning object surfaces, and learning adhesion measurement values for each of the plurality of learning object surfaces, and training to predict adhesion of the object surface when the plurality of index values for the object surface are input based on the dataset.

In an embodiment, the processing unit may process to output a contribution degree indicating that the plurality of indices corresponding to the plurality of index values contribute to predicting the adhesion of the object surface by applying an explainable artificial intelligence algorithm to the adhesion prediction model, and output results of determining the adhesion quality of the object surface and the contribution degrees of the plurality of indices.

In an embodiment, the processing unit may output a prediction accuracy of the adhesion predictive value, which is determined based on a degree to which a contribution degree ranking of preset indices selected from the plurality of indices matches a preset ranking.

According to another embodiment of the invention, an electronic device includes: a display module which includes a display panel, and a cover glass having one surface on which the display panel is adhered and a light-shielding layer formed thereon; a housing which includes an adhesive region to which the light-shielding layer of the cover glass is adhered; and an adhesive layer disposed between the light-shielding layer and the adhesive region to bond the display module and the housing with each other, where a surface of the light-shielding layer has a roughness at which an adhesion predicted by an adhesion prediction model pre-trained for the roughness of the surface satisfies a preset reference adhesion.

According to various embodiments, the method for determining surface adhesion of an object and the device thereof may predict the adhesion of the object surface using an adhesion prediction model trained based on the artificial intelligence, thereby minimizing an occurrence of errors that may occur in conventional adhesion evaluation methods.

According to various embodiments, the method for determining surface adhesion of an object and the device thereof may accurately predict the adhesion of the object while reducing the time and costs in the preparation process for checking the adhesion of the object.

### BRIEF DESCRIPTION OF THE DRAWINGS

The above and other features of embodiments of the disclosure will be more clearly understood from the following detailed description taken in conjunction with the accompanying drawings, in which:

FIG. 1 is a block diagram schematically illustrating the configuration of a device according to an embodiment of the invention;

FIG. 2 is a view illustrating the structure of an object which is a target to determine adhesion in the device according to an embodiment;

FIG. 3 is a table illustrating input data used to predict the adhesion of an object surface using a pre-trained adhesion prediction model in the device according to an embodiment;

FIG. 4 is a block diagram schematically illustrating input data and output data of the pre-trained adhesion prediction model in the device according to an embodiment;

FIG. 5 is a flowchart illustrating the flow of an operation of determining the surface adhesion of the object based on the pre-trained adhesion prediction model in the device according to an embodiment;

FIG. 6 is a block diagram schematically illustrating the artificial intelligence model configured to perform training and input data for training the model in the device according to an embodiment; and

FIG. 7 is a flowchart illustrating the flow of an operation of training the adhesion prediction model to determine the surface adhesion of the object in the device according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms including technical or scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Further, in describing the embodiments with reference to the accompanying drawings, the same reference numerals are denoted to the same components regardless of the number of the drawings, and the same configuration will not be repeatedly described. Further, in description of the embodiments, the publicly known techniques related to the invention, which are verified to be able to make the purport of the invention unnecessarily obscure, will not be described in detail.

In addition, in describing components of the embodiment, the terms such as first, second, A, B, (a), (b), and the like may be used. These terms are intended to divide the components from other components, and do not limit the nature, sequence or order of the components.

It will be understood that when a component is described to as being “connected,” “combined” or “coupled” to another component, the component may be directly connected or coupled the another component, but it may be “connected,” “combined” or “coupled” to the another component intervening another component may be present.

In addition, it will be understood that when a component is described as being “connected” or “combined” by communication to another component, that component may be connected or combined by wireless or wired communication to the another component, but it may be “connected” or “combined” to the another component intervening another component may be present.

Components included in one embodiment and components including common functions will be described using the same names in other embodiments. The description given in one embodiment may be applied to other embodiments, and therefore will not be described in detail within the overlapping range, unless there is a description opposite thereto.

The ‘data’ processed in the device and/or other devices which communicate with the device described in various embodiments of the disclosure may be represented in terms of ‘information’. Here, the information may be used as a concept including the data.

The disclosure relates to a method for determining surface adhesion of an object and a device thereof. To describe in more detail, the disclosure may describe various embodiments of a method for determining adhesion of an object surface using an adhesion prediction model trained based on artificial intelligence and a device thereof.

When describing various embodiments of the disclosure, an object for determining adhesion may include a cover glass formed on an exterior of an electronic device such as a tablet, a smart phone, or a smart watch, etc. For example, the object for determining adhesion (or adhesiveness) may include a cover glass formed on a display of an electronic device.

However, the object for determining adhesion may include various elements such as a display panel, a windshield, a window, etc., which are formed to be transparent, opaque, or translucent, and at least a portion of one surface thereof is configured to adhere to another object (e.g., an object to be bonded (“bonding object”)).

Here, the adhesion may mean a magnitude (e.g., Newton (N)) of a maximum force applied to an object until it is separated from the bonding object while the object is adhered to the bonding object.

That is, according to various embodiments of the disclosure, a method for predicting a magnitude of a force applied to an object adhered to a bonding object until the object is separated from the bonding object based on a pre-trained adhesion prediction model and determining an adhesion quality of the object surface based on the magnitude of the predicted force, and a device thereof will be described.

Hereinafter, various embodiments will be described with reference to the accompanying drawings. However, the drawings accompanying the specification serve to further understand the technical idea together with the detailed description, such that the invention should not be construed as being limited only to the illustrations of the drawings.

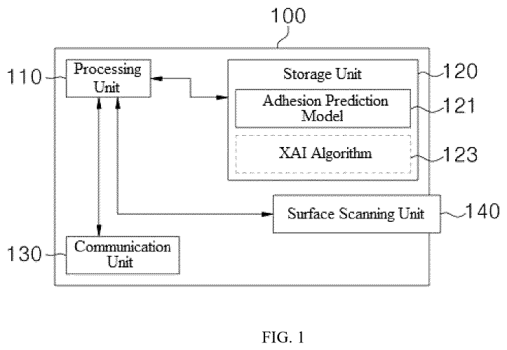

FIG. 1 is a block diagram schematically illustrating the configuration of a device according to an embodiment of the invention.

Referring to FIG. 1, an embodiment of a device 100 may be an adhesion determination device 100. In such an embodiment, the device 100 may include a processing unit 110, a storage unit 120, and a communication unit 130. In addition, the device 100 may further include a surface scanning unit 140 configured to measure the roughness of an object surface for determining adhesion.

The processing unit 110 includes at least one processor (or controller), and may process control commands related to the operations of various components through at least one program (application, tool, plug-in, software, or the like).

In an embodiment, for example, the processing unit 110 may acquire index values of preset indices in relation to the object surface roughness of the object for which adhesion is to be determined.

In various embodiments, indices that can be acquired in relation to the object surface roughness are represented as roughness indices (or briefly, indices), and at least one index selected to determine the adhesion of the object surface (also referred to as “surface adhesion”) among the roughness indices may be represented as preset roughness indices (or briefly, preset indices).

In such embodiments, the index values acquired for the roughness indices may be represented as the values of the roughness indices (or briefly, values of the indices), and the index values acquired for the preset roughness indices may be represented as the values of the preset roughness indices (or briefly, values of the preset indices).

In an embodiment, for example, the processing unit 110 may acquire data stored in the storage unit 120 regarding values of preset indices of the object surface for which adhesion is to be determined, or may receive values of preset indices of the object surface for which adhesion is to be determined through the communication unit 130.

As described above, in various embodiments of the disclosure, the indices may represent roughness indices of the object surface, and the preset indices may represent preset roughness indices of the object surface.

In such embodiments, the values of the indices may represent the values of the roughness indices of the object surface, and the values of the preset indices may represent the values of the preset roughness indices of the object surface.

In embodiments, the values of preset indices received through the communication unit 130 may be data measured through the surface scanning unit 140 configured to measure the roughness of the object surface.

The processing unit 110 may input the acquired values of the preset indices into the pre-trained adhesion prediction model 121, and acquire an adhesion predictive value of the object surface predicted from the adhesion prediction model 121.

The processing unit 110 may determine the adhesion quality (e.g., non-defective or defective) of the object based on the adhesion value predicted for the object surface.

In an embodiment, the processing unit 110 may perform training of the adhesion prediction model 121. In such an embodiment, the processing unit 110 may perform training of the adhesion prediction model 121 using a processor previously included therein.

In another embodiment, the processing unit 110 may include a separate processor for performing training of the adhesion prediction model 121, or a separate learning processing unit (not shown) for performing training of the adhesion prediction model 121.

The learning processing unit (not shown) may be included inside the device 100, but it is not limited thereto, and may also be provided outside the device 100.

In an embodiment, the control commands for processing the above-described operations may be processed through at least one program installed in the device 100. However, it is not limited thereto, and the control commands may also be provided through another program or a temporary installation program previously installed in the storage unit 120.

According to an embodiment, the processing of the control commands may be performed by the processing unit 110 based on at least a portion of a database provided free of charge or for a fee in an external device connected to the device 100.

The operation of the device 100 is performed based on data processing and device control of the processing unit 110, and the processing unit 110 may also perform functions designated on the basis of the control commands received through an input/output unit and/or the communication unit 130 of the device 100.

Further, when processing data acquired through the communication unit 130, the processing unit 110 may process the data based on an identified user. In an embodiment, for example, the processing unit 110 may identify a user by using user information received from a user device connected to the device through the communication unit 130 and/or user information acquired through an input unit (or input/output unit) connected to the device 100, and perform an operation according to the control command input by the identified user.

The storage unit 120 may store various data processed by at least one component (e.g., the processing unit 110 or the communication unit 130) of the device 100. The data may include, for example, a program for processing of the control command, data processed through the program, and/or input data and output data related thereto.

For processing the control commands, the storage unit 120 may include an artificial neural network algorithm, a blockchain algorithm, a deep learning algorithm, a regression analysis algorithm, or an artificial intelligence algorithm based on at least some of mechanisms, operators, language models, and big data related thereto.

The storage unit 120 may store an artificial intelligence model (e.g., the adhesion prediction model 121) pre-trained to predict the adhesion of the object surface using values of preset indices of the object surface as an input and output an adhesion predictive value.

In an embodiment, the pre-trained adhesion prediction model 121 may include at least one selected from algorithms of a multi-layer perceptron (MLP), a convolutional neural network (CNN), a recurrent neural network (RNN), a deep neural network (DNN), and a transformer.

In an embodiment where the adhesion prediction model 121 is generated within the device 100, the storage unit 120 may store at least one learning algorithm for generating the adhesion prediction model 121 through learning.

In an embodiment, for example, the storage unit 120 may store at least one selected from algorithms of various algorithms for training the artificial intelligence model, such as random forest regressor (RF), bagging (or bagging regressor), boosting, stacking, random subspace or the like.

The storage unit 120 may store values of preset indices of the object surface for determining the adhesion. Here, the values of the preset indices stored in the storage unit 120 may be data received by the processing unit 110 through the communication unit 130 or data measured by the processing unit 110 on the surface of the object through the surface scanning unit 140.

Here, the storage unit 120 may store values of preset indices for each object surface of a plurality of objects.

In an embodiment, the storage unit 120 may store an explainable artificial intelligence (XAI) algorithm 123 for describing an operation of the adhesion prediction model 121. Here, the XAI algorithm 123 may be configured to determine a contribution degree indicating that the indices corresponding to each of the values of the preset indices contribute to predicting the adhesion of the object surface, when performing an operation of predicting the adhesion of the object surface based on the values of the preset indices of the object surface by the adhesion prediction model 121.

The storage unit 120 may include data for checking and processing designated control and operations through signals received through each device included in the input/output unit (not shown) and/or the communication unit 130.

The operations of the device 100 are processed by the processing unit 110, and data for processing the related operations, data in process, processed data, preset data, and the like may be stored in the storage unit 120 as a database.

The data stored in the storage unit 120 may be changed, modified, or deleted by the processing unit 110 based on user input of the identified user, and/or new data may be generated and stored in the storage unit 120.

The storage unit 120 may store device setting information of the device 100. The device setting information may be setting information on the device 100 and at least some of the functions and services provided by the device 100.

The storage unit 120 may store user information (or user account) for at least one user. As the user information, at least some piece of information among user identification information, (e.g., identification (ID)), password, and user-customized setting information may be stored. The user-customized setting information is setting information on at least some of control authority and/or the functions of the device 100, and may be set and stored according to the administrator input.

Here, at least some of the user information may be stored as data for operations of at least one program stored in the storage unit 120.

In an embodiment, the storage unit 120 may include a volatile memory, a non-volatile memory, and/or a computer-readable recording medium as known in the art.

In such an embodiment, the computer-readable recording medium may store a computer program for performing the operations according to an embodiment of the invention by the device 100 based on various embodiments of the invention.

According to an embodiment, the storage unit 120 may store one or more programs configured to acquire a plurality of index values for roughness based on a shape of the object surface, input the plurality of index values to the pre-trained adhesion prediction model, output the adhesion predictive value of the object surface, and determine the adhesion quality of the object surface based on the adhesion predictive value.

The communication unit 130 may support establishment of a wired communication channel or establishment of a wireless communication channel between the device 100 and at least one other device (e.g., the user device or an administrator device capable of controlling the device 100), and performing communication through the established communication channel.

The communication unit 130 may perform operations such as modulation/demodulation and encryption/decryption, etc., during performing communication, which is well-known to those skilled in the art, and therefore detailed description thereof will be omitted.

The communication unit 130 is operated dependently on or independently from the processing unit 110, and may include one or more communication processors which support wireless communication and/or wired communication.

According to an embodiment, where the wireless communication is supported, the communication unit 130 may include at least one selected from communication modules of wireless communication modules, for example, a cellular communication module, a near field communication module, and a global navigation satellite system (GNSS) communication module.

According to an embodiment, where the wired communication is supported, the communication unit 130 may include at least one selected from communication modules of wired communication modules, for example, a local area network (LAN) communication module, a power line communication module, a controller area network (CAN) communication module, and a serial peripheral interface (SPI) communication module.

In an embodiment, for example, the communication unit 130 may communicate with the external device by wired and/or wirelessly through near field communication networks such as Bluetooth, Bluetooth Low Energy (BLE), WiFi, WiFi direct, infrared data association (IrDA), ZigBee, UWB, and radio frequency (RF), and/or far field communication networks such as a cellular network, the Internet or a computer network (e.g., LAN or WAN).

Various types of communication modules that form the communication unit 130 may be integrated into one component (e.g., a single chip), or may be implemented as a plurality of separate components (e.g., a plurality of chips).

The communication unit 130 may perform communication with the external device of the device 100 as described above. However, it is not limited thereto, and the communication unit 130 may perform communication with the storage unit 120 and/or at least some of the various components inside the device 100 which are not illustrated (or are illustrated) in FIG. 1.

The surface scanning unit 140 may be configured to measure input data for determining the adhesion of the object surface. Here, the input data for determining the adhesion of the object surface are values of preset indices for the roughness of the object surface, and the surface scanning unit 140 may be configured to measure the values of the preset indices from the object surface.

According to an embodiment, the surface scanning unit 140 may be configured to measure values of preset indices for the roughness of the object surface using a non-destructive laser.

In such an embodiment, the surface scanning unit 140 may include at least one selected from elements of a laser source, an optical system, a detector, a third-dimensional (3D) scanner, a control system, and data processing and analysis software.

In an embodiment, the laser source may be configured to generate a laser beam and project the laser beam onto the object surface to specify a fine structure on the object surface. The optical system may be configured to accurately project the laser beam onto the object surface and collect a beam reflected from the object surface. The detector may be configured to detect the laser beam reflected from the object surface and collect height information of the surface. The detector may include a charge-coupled device (CCD) or a complementary metal oxide semiconductor (CMOS) sensor. The 3D scanner is configured to capture a three-dimensional shape of the object surface, and may be configured to operate based on techniques such as laser scanning, structured light scanning, interferometry and the like. The control system may be configured to control the laser source and the detector, and manage the scanning process. Here, the control system may be configured as at least a portion of the processing unit 110. The data processing and analysis software may be configured to process and analyze the collected data to calculate roughness indices of the object surface, visualize the data, and extract index values for various indices, such as Sa, Sz, Spc, Sq, Sal, Std, Spd, Sk, Smr1, Vvv, or Vmc. The index values for the various indices may be roughness parameters calculated according to ISO 25178-2:2012.

In an embodiment, as described above, the surface scanning unit 140 may perform a non-destructive laser-based surface shape scan on the object surface to determine adhesion, and measure index values for the preset indices.

The surface scanning unit 140 may be provided inside the device 100. However, it is not limited thereto, and the surface scanning unit 140 may be provided outside the device 100 and connected to the device 100 through the communication unit 130.

In an embodiment, although not shown in FIG. 1, the device 100 may further include an input/output unit (not shown). Here, the input/output unit may include an input unit and an output unit.

The input/output unit may include or be connected to at least some of an input unit (not shown) for inputting data, such as a keyboard, mouse, or touch pad, and an output unit (not shown) for outputting data, such as a display unit (e.g., display), speaker, or driving unit.

According to various embodiments of the invention, the device 100 or user device may include another element for performing other functions of a conventional information and communication device, such as a mobile terminal, a multimedia terminal, a wired terminal, a fixed terminal, and an internet protocol (IP) terminal, for example.

The device 100 is a device for processing the control commands, and may perform at least one selected from the functions of a workstation or a large-scale database, or may be connected with the workstation or the large-scale database through communication.

According to various embodiments of the invention, the user device will be described as a device which is connected and communicated with the device 100. For example, although not particularly described with reference to the drawings, the user device may be a mobile device (e.g., a smart phone) of the user, which is connected with the device 100 through wireless communication and transmits user input so that the device 100 performs the operations according to an embodiment of the invention.

In an embodiment, the user device may be connected with the device 100 through at least one program installed therein, or may be connected with the device 100 through at least one online webpage provided by the device 100.

In such an embodiment, the device 100 may perform at least some of the functions of a server and/or a terminal.

The server is one entity that exists on a network, and performs roles of a web server, a database server, and an application server. According to an embodiment, the server may provide various services to the device 100 and/or the user device based on processing of the device 100.

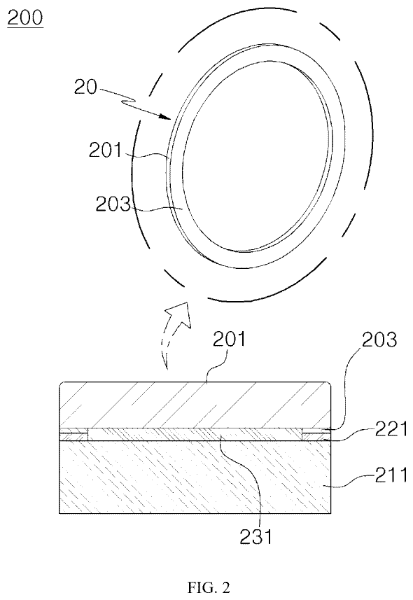

FIG. 2 is a view illustrating the structure of an object which is a target to determine adhesion in the device according to an embodiment.

Particularly, FIG. 2 may illustrate an object 201 (e.g., cover glass) for which adhesion is determined by the device 100, and a bonding object 211 (e.g., housing) to which the object is adhered.

Referring to FIG. 2, in an embodiment, the object 201 may be a cover glass having a circular plate shape. The object 201 may include or be formed of at least one selected from various materials having transparency, such as soda-lime glass, aluminosilicate glass, polycarbonate (PC), polymethyl methacrylate (PMMA, acrylic), or polyimide, etc.

According to an embodiment, the object 201 may have a circular shape as shown in a three-dimensional drawing 20, which is three-dimensionally illustrated in terms of the shape and configuration thereof. However, it is not limited thereto, and the object 201 may be formed in one of other various geometric shapes such as a triangle, a square, a pentagon, or a non-geometric shape. In an embodiment, where the object 201 has a geometric shape, the vertices may be formed as curves, i.e., rounded.

In an embodiment, as described above, the object 201 may be formed as a flat plate, but not being limited thereto. Alternatively, at least a portion of the object 201 may be formed as a curved surface or formed by being bent to have a predetermined angle.

The object 201 having one surface as an adhesive surface may be adhered to the bonding object 211 through an adhesive layer 221. Here, the adhesive layer 221 may be a layer formed by applying an adhesive (or glue) or bonding an adhesive in the form of a sheet (or film) to the one surface of the object 201.

In such an embodiment, the object surface for determining the adhesion may be a surface of the adhesive surface of the object 201. However, it is not limited thereto, and the object surface for determining the adhesion may be a surface of a light-shielding layer 203 formed on a portion of the adhesive surface of the object 201.

According to an embodiment, the light-shielding layer 203 formed on the object 201 may include a black matrix ink layer (or black matrix layer) formed on an edge region (or edge portion) of the adhesive surface of the object 201. However, the light-shielding layer 203 may include or be formed of at least one selected from various materials for controlling the transmission or interference of light passing through the object 201, such as a black coating layer or an optical patterned layer (OPA).

The object 201 may be bonded to the bonding object 211 in a way such that the surface of the light-shielding layer 203 formed on the object 201 is bonded to the adhesive layer 221 in a state where the adhesive layer 221 is formed in an adhesive region of the bonding object 211.

However, it is not limited thereto, and alternatively, the adhesive layer 221 may be formed on at least a portion of the adhesive surface of the object 201 (or the light-shielding layer 203 formed on the adhesive surface of the object 201), and then the adhesive layer 221 may be bonded to the adhesive region of the bonding object 211.

When the adhesive surface of the object 201 is adhered to the adhesive layer 221 (when the light-shielding layer 203 is not formed), the object surface for determining the adhesion may be the surface of the adhesive surface of the object 201.

At least one display panel (or a panel (PNL)) 231 may be disposed between the object 201 and the bonding object 211.

In an embodiment, an electronic device 200 including a display may include a display module in which a display panel 231 is bonded to the adhesive surface of the cover glass (e.g., the object 201), and the display panel 231 is configured to be drivable.

In such an embodiment, the light-shielding layer 203 may be formed on at least some regions of the adhesive surface (e.g., the edge region) of the cover glass (the object 201) included in the display module.

In such an embodiment, the display panel 231 may be adhered to the cover glass (the object 201) such that at least a portion thereof is overlapping or not overlapping at least a portion of the light-shielding layer 203 formed on the surface of the cover glass (the object 201) adhered to the cover glass (the object 201).

The light-shielding layer 203 formed on the adhesive surface of the cover glass (the object 201) (or exposed to an outside on the adhesive surface) may be adhered to the housing (e.g., the bonding object 211) through the adhesive layer 221.

In an embodiment, as described above, the cover glass (the object 201) (or the display module) is adhered to the housing (the bonding object 211), and the display panel 231 may be mounted (or placed) inside the housing (the bonding object 211).

The display panel 231 may be one of various types of display panels, such as a liquid crystal display (LCD), an organic light emitting diode (OLED), a quantum dot light emitting diode (QLED), a micro light emitting diode (micro-LED), a mini light emitting diode (Mini LED), a transparent display, an electronic paper display (E-Paper), and a quantum dot organic light emitting diode (QD-OLED), for example.

In an embodiment, the display panel 231 may be implemented as a flexible display.

According to various embodiments, in the object 201 forming the electronic device 200, the light-shielding layer 203 may be formed to have a roughness at which an adhesion predicted by the adhesion prediction model 121 pre-trained for the surface roughness of the light-shielding layer 203 satisfies a preset reference adhesion.

In such embodiments, as described above, the electronic device 200 including the object 201 (or the display module including the object 201) may be implemented as various devices including the display, such as a tablet computer, a smart phone, or a smart watch, etc.

In addition, at least one surface of the electronic device 200 or the bonding object 211 (e.g., the housing) to which the object 201 is adhered in the electronic device 200 may be formed to have a form of various shapes, such as a circle, a triangle, a square, or a pentagon, etc.

Hereinafter, various embodiments of a method for determining surface adhesion of the cover glass (the object 201) and a device thereof will be described.

In an embodiment, the determination of whether the surface adhesion of the object 201 satisfies the preset reference adhesion may be performed through the pre-trained adhesion prediction model 121. The adhesion prediction model 121 may be configured to determine the adhesion of the object surface based on the values of preset indices of the object surface.

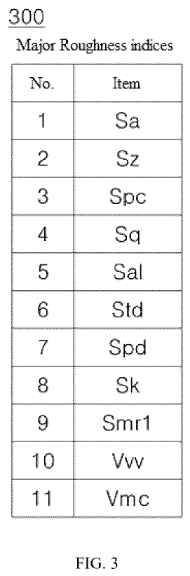

FIG. 3 is a table illustrating input data used to predict the adhesion of an object surface using the pre-trained adhesion prediction model in the device according to an embodiment.

Here, the preset indices of the object surface may include at least one selected from items of indices for the roughness that can be measured on the object surface, for example, arithmetical mean height (Sa), maximum height (Sz), arithmetic mean peak curvature (Spc), root mean square height (Sq), auto-correlation length (Sal), texture direction (Std), density of peaks (Spd), core height (Sk), peak material portion (Smr1), dale void volume (Vvv), and core material volume (Vmc).

In an embodiment, for example, the preset indices of the object surface include the arithmetic mean peak curvature (Spc) or the core material volume (Vmc) among the above-described 11 indices.

According to an embodiment, as described above, the values of preset indices of the object surface input into the adhesion prediction model 121 for determining the adhesion of the object surface include at least one selected from values of the items among the arithmetical mean height (Sa), maximum height (Sz), arithmetic mean peak curvature (Spc), root mean square height (Sq), auto-correlation length (Sal), texture direction (Std), density of peaks (Spd), core height (Sk), peak material portion (Smr1), dale void volume (Vvv), and core material volume (Vmc) of the object surface.

However, it is not limited thereto, and the preset indices of the object surface (or the values of the preset indices) may include indices for the roughness that can be measured on the object surface, for example, at least one selected from items (or values thereof) among surface texture (Str), surface area ratio (Sdr), surface skewness (Ssk), surface kurtosis (Sku), peak height (Sp), valley depth (Sv), surface slope angle (Sdq), peak height (Spk), valley depth (Svk), material ratio (Smr2), material ratio (Sxp), valley volume (Vvc), peak volume (Vmp), arithmetic average roughness (Ra), ten-point mean roughness (Rz), mean spacing (RSm), maximum peak height (Rp), maximum valley depth (Rv), mean contour height (Rc), total height (Rt), root mean square roughness (Rq), surface skewness (Rsk), surface kurtosis (Rku), slope difference (RAq), material ratio curve (Rmr(c)), slope change (Rδc), material ratio (Rmr), Japanese Industrial Standard Rz (RzJIS), core roughness (Rk), first material ratio (Mr1), second material ratio (Mr2), reduced peak height (Rpk), reduced valley height (Rvk), surface area (A1), surface area (A2), hybrid surface characterization (HSC), number of peaks per centimeter (Pc/cm), number of peaks (RPc), contour length (RLo), roller length (Rlr), mean slope difference (RΔa), mean wavelength difference (Rλa), slope change (RΔq), and mean wavelength difference (Rλq).

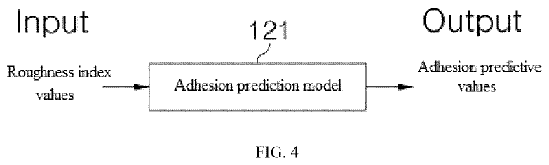

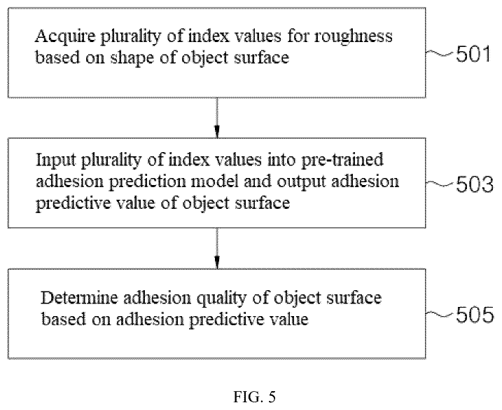

Hereinafter, an operation of determining surface adhesion of an object by the device 100 according to an embodiment based on the pre-trained adhesion prediction model 121 will be described with reference to FIGS. 4 and 5.

FIG. 4 is a block diagram schematically illustrating input data and output data of the pre-trained adhesion prediction model in the device according to an embodiment. FIG. 5 is a flowchart illustrating the flow of the operation of determining the surface adhesion of the object based on the pre-trained adhesion prediction model in the device according to an embodiment.

In an embodiment, referring to FIG. 4, the pre-trained adhesion prediction model 121 may be configured to input values of preset indices of the object surface for determining adhesion as described above, and output the adhesion predictive value of the object surface.

In such an embodiment, the preset indices may preset in advance. According to an embodiment, the preset indices may include at least one selected from the indices listed above.

In an embodiment, for example, the preset indices may include 11 (or more) indices of arithmetical mean height (Sa), maximum height (Sz), arithmetic mean peak curvature (Spc), root mean square height (Sq), auto-correlation length (Sal), texture direction (Std), density of peaks (Spd), core height (Sk), peak material portion (Smr1), dale void volume (Vvv), and core material volume (Vmc) among the indices listed above.

In an embodiment, for example, the preset indices include the arithmetic mean peak curvature (Spc), or the core material volume (Vmc).

In such an embodiment, the adhesion prediction model 121 may be trained based on a training dataset which includes at least selected from the values of preset indices acquired for each of various objects.

The adhesion prediction model 121 may be trained to predict the adhesion of the surface of an object 201 by inputting values of preset indices of the surface of the object 201 for which adhesion is to be determined as described above.

Hereinafter, an embodiment of the operation of determining adhesion of the object surface using the pre-trained adhesion prediction model 121 will be described in greater detail with reference to FIG. 5.

In an embodiment, the processing unit 110 may acquire a plurality of index values (e.g., values of preset indices) for the roughness based on the shape of the object surface (process 501).

In an embodiment, where the object 201 for which adhesion is to be determined is a cover glass of a smart watch, the processing unit 110 may acquire index values of each of preset indices in relation to the roughness of the surface of the cover glass.

However, it is not limited thereto, and the object surface may be a surface of the light-shielding layer 203 formed on at least a portion (e.g., the edge portion) of one surface (e.g., the adhesive surface) of the object 201.

Accordingly, the processing unit 110 may acquire values of preset indices for the surface of the light-shielding layer formed on the cover glass.

Here, the processing unit 110 may acquire values of preset indices for the surface of the object 201 (or the surface of the light-shielding layer 203 formed on the object 201) from the storage unit 120.

However, the processing unit 110 may measure and acquire values of preset indices from the surface of the object 201 (or the surface of the light-shielding layer 203 formed on the object 201) for determining the adhesion using the surface scanning unit 140.

In an embodiment, where the preset indices include the mean curvature of the peak (Spc) and the core material volume (Vmc), the processing unit 110 may acquire the mean curvature of the peak (Spc) value and the core material volume (Vmc) value as the values of the preset indices.

In an embodiment, as described above, values of the arithmetic mean peak curvature (Spc) and the core material volume (Vmc) may be obtained as the values of preset indices acquired by the processing unit 110. However, it is not limited thereto, and the processing unit 110 may be configured to acquire values for at least one selected from the preset indices listed above that can be measured from the object surface as described above.

According to an embodiment, the preset indices may be determined based on the roughness indices used in the learning process of the adhesion prediction model 121.

In an embodiment, as the preset indices, the processing unit 110 may set the same roughness indices as the learning roughness indices used in the learning process of the adhesion prediction model 121. Based on this state, the processing unit 110 may acquire the values of the preset indices of the object surface in the process 501.

In an embodiment, the processing unit 110 may input the plurality of index values (values of preset indices) into the pre-trained adhesion prediction model and output the adhesion predictive value of the object surface (process 503).

In an embodiment, the adhesion prediction model 121 may include a plurality of decision trees for performing an operation of predicting adhesion using the values of the preset indices.

The plurality of decision trees formed in the adhesion prediction model 121 may independently perform the operation of predicting adhesion of the object with respect to the input values of the preset indices.

Thereafter, the adhesion prediction model 121 may calculate an average value of the tree adhesion predictive values predicted by each of the plurality of decision trees, and determine the calculated average value as the adhesion predictive value of the object surface.

In such an embodiment, the adhesion predictive value of the object surface may be a value predicted as the maximum force (e.g., Newton (N)) applied when the object is separated from the bonding object 211 while the object 201 is adhered to the bonding object 211 as described above.

In an embodiment, the object surface (the surface of the adhesive surface of the object 201 or the surface of the light-shielding layer 203 formed on the adhesive surface of the object 201) is adhered to the bonding object 211 through the adhesive layer 221, and the adhesion predictive value may be the maximum force (e.g., Newton (N)) applied when the object surface is separated from the adhesive layer 221 while the object 201 is adhered to the bonding object 211 with the adhesive layer 221 interposed therebetween.

In an embodiment, the processing unit 110 may determine the adhesion quality of the object surface based on the adhesion predictive value (process 505).

According to an embodiment, the processing unit 110 may determine the adhesion quality as non-defective if the adhesion predictive value acquired from the adhesion prediction model 121 exceeds (or is equal to or greater than) a preset value, and may determine the adhesion quality as defective if the adhesion predictive value is equal to or less than (or below) the preset value.

In an embodiment, for example, when the adhesion (unit: N) acquired from the adhesion prediction model 121 exceeds (or is equal to or greater than) the preset reference adhesion (unit: N), the processing unit 110 may determine the adhesion quality of the surface of the object 201 as non-defective, and output the determined result (e.g., non-defective) through the preset output unit.

In such an embodiment, when the adhesion (unit: N) acquired from the adhesion prediction model 121 is equal to or lower than (or below) the preset reference adhesion (unit: N), the processing unit 110 may determine the adhesion quality of the surface of the object 201 as defective, and outputs the determined result (e.g., defective) through the preset output unit.

In addition, according to various embodiments, the processing unit 110 may process the object 201 to be classified based on the determined results of the non-defective or defective in terms of the adhesion quality.

When it is confirmed that the process 505 has been performed, the processing unit 110 may terminate the execution of procedures in FIG. 5.

According to various embodiments, in process 503 or a subsequent process, the processing unit 110 may analyze a contribution degree indicating that the plurality of indices (e.g., preset indices) corresponding to the plurality of index values (e.g., values of preset indices) contribute to predicting the adhesion of the object surface by applying an XAI algorithm 123 to the adhesion prediction model 121. In addition, the processing unit 110 may output the analyzed contribution degree.

In an embodiment, the processing unit 110 may analyze (and/or interpret) the contribution degree indicating that the preset indices contribute to predicting the adhesion of the object surface based on Local Interpretable Model-agnostic Explanations (LIME), SHapley Additive explanations (SHAP), or feature importance during performing the operation of predicting the adhesion of the object surface by the adhesion prediction model 121.

The processing unit 110 may output results of analyzing the contribution degrees for each of the preset indices in the visualization form, such as a SHAP Value Plot, a LIME Explanation Plot, or a Feature Importance Plot.

In addition, the processing unit 110 may output the contribution degrees for each of the preset indices in the text form, such as a percentage (%), or output them by applying at least some of the visualization forms thereto.

The processing unit 110 may output the contribution degree analysis results after performing the process 505. However, it is not limited thereto, the processing unit 110 may output the contribution degree analysis results during performing the process 503 or in its subsequent operation.

According to an embodiment, after performing the process 505, the processing unit 110 may output at least some of the adhesion predictive value of the object 201 (or the object surface) acquired from the adhesion prediction model 121, the adhesion quality for the object 201 (or the object surface), and the contribution degrees acquired for each of the preset indices.

The processing unit 110 may generate a report including at least some of the adhesion predictive value of the object 201 (or the object surface), the adhesion quality for the object 201 (or the object surface), and the contribution degrees acquired for each of the preset indices, and output the generated report.

According to various embodiments, the processing unit 110 may output the report by including a prediction accuracy of the adhesion predictive value, which is determined based on a degree to which a contribution degree ranking of at least some preset indices among the plurality of indices (preset indices) match a preset ranking.

In an embodiment, the processing unit 110 may determine a similarity (%) by comparing the ranking of specific indices (e.g., arithmetic mean peak curvature (Spc) and/or core material volume (Vmc)) among the preset indices with the ranking set for the specific indices.

In an embodiment, the specific indices may be some of the preset indices as described above, but not being limited thereto. In another embodiment the specific indices may be composed of all of the preset indices.

Here, the preset ranking intended to compare with the contribution degree ranking of the specific indices may be determined in the learning process of the adhesion prediction model 121. In an embodiment, for example, the preset ranking intended to compare with the contribution degree ranking of the specific indices may be based on the results acquired by applying the XAI algorithm 123 to the adhesion prediction model 121 (or an artificial intelligence model 601) which is being trained or has been trained, and may be set according to the contribution degree ranking in which the specific indices are confirmed as contributing to predicting the adhesion of the object surface.

In such an embodiment, the processing unit 110 determines that the higher the similarity, the higher the prediction accuracy of the adhesion predictive value predicted by the adhesion prediction model 121, and may determine the prediction accuracy as a percentage value (%).

The processing unit 110 may output the similarity or the prediction accuracy of adhesion predictive value together with the output of the adhesion predictive value, or include it in the report.

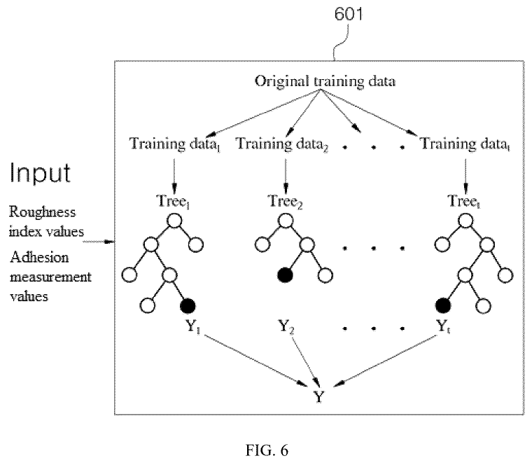

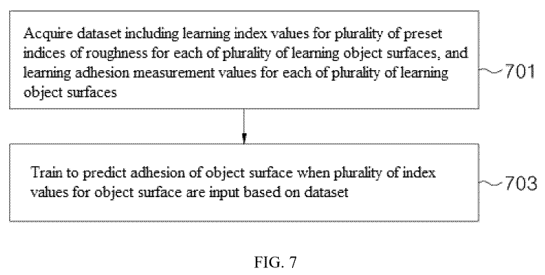

Hereinafter, an embodiment of an operation of performing training to generate the adhesion prediction model 121 by the device 100 will be described with reference to FIGS. 6 and 7.

FIG. 6 is a block diagram schematically illustrating the artificial intelligence model configured to perform training and input data for training the model in the device according to an embodiment. FIG. 7 is a flowchart illustrating the flow of an operation of training the adhesion prediction model to determine the surface adhesion of the object in the device according to an embodiment.

In an embodiment, referring to FIG. 6, the adhesion prediction model 121 may be generated through training of the artificial intelligence model 601 configured to predict the adhesion (unit: N) for the surface of an object by inputting the values of preset indices for the surface of the object.

The artificial intelligence model 601 may be configured to perform training based on the learning algorithm such as random forest regressor (RF), bagging (or bagging regressor), boosting, stacking, random subspace or the like.

A dataset for training the artificial intelligence model 601 may include values of preset indices acquired for each of a plurality of learning objects, and adhesion measurement values acquired for each of the learning objects.

The processing unit 110 may perform training the artificial intelligence model 601 using the dataset acquired for each of the plurality of learning objects to generate the adhesion prediction model 121.

In embodiments, as described above, the adhesion prediction model 121 may be generated by training the artificial intelligence model 601. In such an embodiment, it would be understood that the adhesion prediction model 121 is generated by training, and the artificial intelligence model 601 may be represented as the adhesion prediction model 121.

Hereinafter, an embodiment of the operation of training the adhesion prediction model 121 will be described in greater detail with reference to FIG. 7.

In an embodiment, the processing unit 110 may acquire a dataset including learning index values for the plurality of preset indices of the roughness for each of the plurality of learning object surfaces, and learning adhesion measurement values for each of the plurality of learning object surfaces (process 701).

In such an embodiment, the storage unit 120 may store the dataset including values of preset indices acquired for each of the plurality of learning objects, and adhesion measurement values acquired for each of the learning objects.

The processing unit 110 may perform preprocessing on data included in the dataset. According to an embodiment, the processing unit 110 may perform preprocessing, such as missing value processing, outlier removal, data normalization, or standardization, on at least some of the data acquired for each of the plurality of learning objects of the dataset (e.g., the index values for the preset indices and learning adhesion measurement values).

The processing unit 110 may divide (or split) the preprocessed dataset into a training dataset and a verification dataset.

In an embodiment, the processing unit 110 may perform training of the adhesion prediction model 121 using the dataset (process 703).

In such an embodiment, the adhesion prediction model 121 may train the relationship between the input and the output by using the values of preset indices for each of the plurality of learning objects of the dataset as an input, and using the adhesion measurement values corresponding to each of the learning objects as an output.

According to an embodiment, the adhesion prediction model 121 may perform learning based on at least one preset learning algorithm selected from the learning algorithms such as random forest regressor (RF), bagging (or bagging regressor), boosting, stacking, random subspace or the like.

The processing unit 110 may evaluate the performance of the trained adhesion prediction model 121 using the verification dataset. According to an embodiment, the processing unit 110 may analyze a difference between the adhesion predictive value of the adhesion prediction model 121 trained using the verification dataset and the actual adhesion measurement value, and measure the accuracy of the adhesion prediction model 121.

In such an embodiment, the processing unit 110 may optimize the performance of the adhesion prediction model 121 by tuning (or adjusting) hyperparameters, and may repeatedly perform at least some operations of training, evaluating and tuning of the adhesion prediction model 121.

If it is confirmed that the process 703 has been performed, the processing unit 110 may terminate the execution of procedures in FIG. 7.

According to various embodiments, the processing unit 110 may analyze the contribution degree indicating that the preset indices contribute to predicting the adhesion of the object surface by applying the XAI algorithm 123 to the adhesion prediction model 121 in the learning process thereof or to the adhesion prediction model 121 in which training has been completed.

The processing unit 110 may check the order in which the preset indices contribute to predicting the adhesion of the object surface, and label the contributing order to the corresponding index among the preset indices.

According to embodiments, as described above, the training of the adhesion prediction model 121 may be performed by the processing unit 110 within the device 100. However, it is not limited thereto, and the training of the adhesion prediction model 121 may be performed outside the device 100, and the processing unit 110 may store the trained adhesion prediction model 121 in the reception and storage unit 120.

According to various embodiments of the invention, an electronic device 200 includes: a display module which includes a display panel, and a cover glass having one surface on which the display panel is adhered and a light-shielding layer formed thereon; a housing which includes an adhesive region to which the light-shielding layer of the cover glass is adhered; and an adhesive layer disposed between the light-shielding layer and the adhesive region to bond the display module and the housing with each other, where a surface of the light-shielding layer has a roughness at which an adhesion predicted by an adhesion prediction model pre-trained for the roughness of the surface satisfies a preset reference adhesion.

According to various embodiments, the method for determining surface adhesion of an object and the device thereof may predict the adhesion of the object surface using an adhesion prediction model trained based on the artificial intelligence, thereby minimizing an occurrence of errors that may occur in conventional adhesion evaluation methods.

According to various embodiments, the method for determining surface adhesion of an object and the device thereof may accurately predict the adhesion of the object while reducing the time and costs in the preparation process for checking the adhesion of the object.

According to embodiments of the invention, the functions of various embodiments described as being performed by the device 100 are operations processed through the processing unit 110 of the device 100, and may be performed by organically being connected to the device 100 and/or components of the device connected to the device 100.

In embodiments of the invention, any function performed by the device 100 has been described through various embodiments, but if a component that performs the corresponding function is not described as a component of the device 100, it should be understood that the device 100 includes a commonly known component that performs the function and/or is connected thereto.

The invention should not be construed as being limited to the embodiments set forth herein. Rather, these embodiments are provided so that this disclosure will be thorough and complete and will fully convey the concept of the invention to those skilled in the art.

For example, adequate effects or results may be achieved even if the foregoing processes and methods are carried out in different order than those described above, and/or the above-described elements, such as systems, structures, devices, or circuits, are combined or coupled in different forms and modes than those described above, or substituted or switched with other components or equivalents.

In particular, when describing with reference to the flowchart, it has been described that a plurality of processes are configured and the processes are sequentially executed in a designated order, but it is not necessarily limited to the designated order.

In other words, executing by changing or deleting at least some of the steps described in the flowchart or adding at least one process is applicable as an embodiment, and executing one or more processes in parallel may also be applicable as an embodiment. That is, it is not limited to that the processes are necessarily operated in a time-series order, and should be included in various embodiments of the invention.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A method for determining surface adhesion of an object, the method comprising:
acquiring a plurality of index values for roughness based on a shape of an object surface;
inputting the plurality of index values into a pre-trained adhesion prediction model, and outputting an adhesion predictive value of the object surface; and
determining an adhesion quality of the object surface based on the adhesion predictive value.

2. The method according to claim 1, wherein the plurality of index values comprises index values measured for a plurality of preset indices selected from roughness indices including arithmetical mean height (Sa), maximum height (Sz), arithmetic mean peak curvature (Spc), root mean square height (Sq), auto-correlation length (Sal), texture direction (Std), density of peaks (Spd), core height (Sk), peak material portion (Smr1), dale void volume (Vvv), and core material volume (Vmc).

3. The method according to claim 1, wherein the object is a cover glass having one surface as an adhesive surface, and a region of the adhesive surface is adhered to a bonding object, which is an object to be bonded, and
the object surface is a surface of a black matrix ink layer formed in the region of the adhesive surface of the object.

4. The method according to claim 1, wherein the plurality of index values includes values measured for a plurality of preset indices of the roughness through a non-destructive laser-based surface shape scan of the object surface.

5. The method according to claim 1, wherein the surface adhesion is a maximum force applied to the object until the object is separated from a bonding object, which is an object to be bonded, while the object is adhered to the bonding object.

6. The method according to claim 1, wherein the determining an adhesion quality comprises determining the adhesion quality as non-defective if the adhesion predictive value exceeds a preset value, and determining the adhesion quality as defective if the adhesion predictive value is the preset value or less.

7. The method according to claim 1, wherein the pre-trained adhesion prediction model is generated by
acquiring a dataset which includes learning index values for a plurality of preset indices of the roughness for each of a plurality of learning object surfaces, and learning adhesion measurement values for each of the plurality of learning object surfaces, and
training to predict adhesion of the object surface when the plurality of index values for the object surface are input based on the dataset.

8. The method according to claim 1, wherein the outputting the adhesion predictive value comprises outputting a contribution degree indicating that each of the plurality of indices corresponding to the plurality of index values contributes to predicting the adhesion of the object surface by applying an explainable artificial intelligence algorithm to the adhesion prediction model.

9. The method according to claim 8, further comprising, after the determining the adhesion quality of the object surface, outputting results of determining the adhesion quality of the object surface and the contribution degrees of the plurality of indices.

10. The method according to claim 8, wherein the outputting the adhesion predictive value comprises outputting a prediction accuracy of the adhesion predictive value, which is determined based on a degree to which a contribution degree ranking of preset indices selected from the plurality of indices matches a preset ranking.

11. A device for determining surface adhesion of an object, the device comprising:
a storage unit which stores a pre-trained adhesion prediction model; and
a processing unit which acquires a plurality of index values for roughness based on a shape of an object surface, inputs the plurality of index values into the pre-trained adhesion prediction model, outputs an adhesion predictive value of the object surface, and determines an adhesion quality of the object surface based on the adhesion predictive value.

12. The device according to claim 11, wherein the plurality of index values comprises index values measured for a plurality of preset indices selected from roughness indices including arithmetical mean height (Sa), maximum height (Sz), arithmetic mean peak curvature (Spc), root mean square height (Sq), auto-correlation length (Sal), texture direction (Std), density of peaks (Spd), core height (Sk), peak material portion (Smr1), dale void volume (Vvv), and core material volume (Vmc).

13. The device according to claim 11, wherein the object is a cover glass having one surface as an adhesive surface, and a region of the adhesive surface is adhered to a bonding object, which is an object to be bonded, and
the object surface is a surface of a black matrix ink layer formed in the region of the adhesive surface of the object.

14. The device according to claim 11, further comprising a surface scanning unit which measures the plurality of index values for the roughness of the object surface through a non-destructive laser-based surface shape scan,
wherein the processing unit performs the non-destructive laser-based surface shape scan on the object surface through the surface scanning unit, and processes to acquire the plurality of index values measured for the roughness.

15. The device according to claim 11, wherein the surface adhesion is a maximum force applied to the object until it is separated from a bonding object, which is an object to be bonded, while the object is adhered to the bonding object.

16. The device according to claim 11, wherein the processing unit determines the adhesion quality as non-defective if the adhesion predictive value exceeds a preset value, and determines the adhesion quality as defective if the adhesion predictive value is the preset value or less.

17. The device according to claim 11, wherein the processing unit generates the pre-trained adhesion prediction model by acquiring a dataset which includes learning index values for a plurality of preset indices of the roughness for each of a plurality of learning object surfaces, and learning adhesion measurement values for each of the plurality of learning object surfaces, and training to predict adhesion of the object surface when the plurality of index values for the object surface are input based on the dataset.

18. The device according to claim 11, wherein the processing unit processes to output a contribution degree indicating that the plurality of indices corresponding to the plurality of index values contribute to predicting the adhesion of the object surface by applying an explainable artificial intelligence algorithm to the adhesion prediction model, and
outputs results of determining the adhesion quality of the object surface and the contribution degrees of the plurality of indices.

19. The device according to claim 18, wherein the processing unit outputs a prediction accuracy of the adhesion predictive value, which is determined based on a degree to which a contribution degree ranking of preset indices selected from the plurality of indices matches a preset ranking.

20. An electronic device comprising:
a display module which includes a display panel, and a cover glass having one surface on which the display panel is adhered and a light-shielding layer formed thereon;
a housing which includes an adhesive region to which the light-shielding layer of the cover glass is adhered; and
an adhesive layer disposed between the light-shielding layer and the adhesive region to bond the display module and the housing with each other,
wherein a surface of the light-shielding layer has a roughness at which an adhesion predicted by an adhesion prediction model pre-trained for the roughness of the surface satisfies a preset reference adhesion.
